(19) United States
(12) Patent Application Publication
(10) Pub. No.: US 2004/0052203 A1
(43) Pub. Date: Mar. 18, 2004

(54) Light enabled RFID in information disks

(76) Inventor: Brian W. Brollier, Cincinnati, OH (US)

Correspondence Address: Lorri W. Cooper, Esq., JONES, DAY, REAVIS & POGUE, North Point, 901 Lakeside Avenue, Cleveland, OH, 44114, US

(21) Appl. No.: 10/243,602

(22) Filed: Sep. 13, 2002

(51) Int. Cl. G11B 3/70; G11B 5/84; G11B 7/26; G08B 13/14

(52) U.S. Cl. 369/273; 340/572.7

(57) ABSTRACT

An information disk has a disk structure with a metalized data storage area. A radio frequency identification processor that is activatable by light, such as laser light, is coupled to the disk structure to prevent copying of copyrighted or otherwise secured data, and to prevent unauthorized use of the information disk. The processor may be positioned at a variety of locations on the information disk, including in the inner non-conductive area, and the outer non-conductive ring, as well as within the metalized data storage area. A process for enabling an information disk with an RFID processor includes providing a disk structure having a metalized data storage area, and positioning a short wavelength electromagnetic light activated radio frequency identification processor on the disk structure.

### FIELD OF THE INVENTION

This invention relates to wireless communication systems. In particular, the invention relates to the implementation of radio frequency identification components in information media to prevent the unauthorized use of copyrighted or otherwise secured works.

### BACKGROUND

Radio frequency identification (RFID) technology has been used for wireless automatic identification. An RFID system typically includes a transponder, also referred to as a tag, an antenna, and a transceiver with a decoder. The tag includes a radio frequency integrated circuit and the antenna serves as a pipeline between the circuit and the transceiver. Data transfer between the tag and transceiver is wireless. RFID systems may provide non-contact, non-line of sight communication.

RF tag “readers” utilize an antenna as well as a transceiver and decoder. When a tag passes through an electromagnetic zone of a reader, it is activated by the signal from the antenna. The transceiver decodes the data on the tag and this decoded information is forwarded to a host computer for processing. Readers or interrogators can be fixed or handheld devices, depending on the particular application.

Several different types of tags are utilized in RFID systems, including passive, semi-passive, and active tags. Each type of tag may be read only or read/write capable. Passive tags obtain operating power from the radio frequency signal of the reader that interrogates the tag. Semi-passive and active tags are powered by a battery, which generally results in greater read range. Semi-passive tags may operate on a timer and periodically transmit information to the reader. Tags may also be activated when they are read or interrogated by a reader. Tags may control their output, which allows them to activate or deactivate apparatus remotely. Active tags can initiate communication, whereas passive and semi-passive tags are activated only when they are read by another device first. Active tags can supply instructions to a machine such that the machine may report its performance to the tag. Multiple tags may be located in a radio frequency field and may be read individually or simultaneously.

### SUMMARY

According to the invention, an information disk comprises a disk structure having a metalized data storage area and a short wavelength electromagnetic light activated radio frequency identification processor coupled to the disk structure.

The processor may be embedded in the disk structure. The disk structure may include a surface and a protective coating that covers at least a part of the surface, with the processor being coupled between the surface and the protective coating. A recess may be positioned on the surface of the disk. The recess is sized for receiving the processor.

The structure of the information disk has an outer periphery and a center. In one embodiment, the processor is positioned at the outer periphery. In another embodiment, the metalized data storage area is positioned adjacent the outer periphery, and the processor is positioned between the center and the metalized data storage area. In yet another embodiment, the processor is coupled to the disk structure between the outer periphery and the center. In this latter embodiment, the metalized data storage area may comprise a data free portion, and the processor is coupled to the disk structure in the data free portion.

The processor may have a photo-active side that is oriented on the disk structure in a direction to allow activation of the processor by short wavelength electromagnetic light. The processor may be coupled to the disk structure with an adhesive.

The disk structure may include two disk layers that are bonded together. The processor may be positioned between the two disk layers. The processor may alternatively be coupled to an exterior surface of one of the disk layers.

The processor is preferably responsive to short wavelength electromagnetic light having a wavelength between about 1 nanometers and about 25 micrometers. In a more preferred embodiment, the processor is responsive to short wavelength electromagnetic light having a wavelength between about 380 nanometers and 750 nanometers. The light may be laser light.

The information disk may be one of a CD-ROM, a CD-R, a CD-RW, a DVD-ROM, a DVD-R(G), a DVD-R(A), a DVD-RW, a DVD-RAM, a DVD+RW, and a DVD+R.

In an alternative embodiment of the invention, an information disk comprises a disk structure having a metalized data storage area and a radio frequency identification processor coupled to the disk structure. The processor is enabled by light having a frequency ranging from about 300 GHz to about 3×10¹⁷ Hz. In another embodiment, the processor is activatable by a light from an external source. The light is in at least one of the ultra-violet, visible, and infrared light areas of the electromagnetic spectrum. The light may be laser light.

In another embodiment of the invention, an information disk comprises a disk structure having a metalized data storage area, a short wavelength electromagnetic light activated radio frequency identification processor coupled to the disk structure, and an antenna electrically coupled to the processor. The antenna may be internal to and integral with the processor. Alternatively, the antenna may be coupled to the disk structure.

The disk structure may include a disk surface and the processor and antenna are positioned on the disk surface. A protective coating may be positioned over the disk surface, processor, and antenna.

The disk structure may include a center and an outer periphery. In one embodiment, the metalized data storage area is positioned on the disk surface near the outer periphery, and the antenna and processor are positioned on the disk surface between the metalized data storage area and the center. An opening may be positioned in the center of the disk structure, and the antenna may be an annular ring of conductive material. The processor may be positioned between the annular ring of conductive material and the metalized data storage area. The antenna may be one of loop-shaped, dipole, or folded dipole. In another embodiment, the metalized data storage area is positioned on the disk surface near the outer periphery, and the antenna and processor are positioned between the metalized data storage area and the outer periphery. In yet another embodiment, the metalized data storage area is the antenna and the processor is positioned in the metalized data storage area.

According to another aspect of the invention, a process of enabling an information disk with an RFID processor comprises providing a disk structure having a metalized data storage area and positioning a short wavelength electromagnetic light activated radio frequency identification processor on the disk structure. The process may also include coating the disk structure with a coating to cover the processor and the metalized data storage area.

The providing step may include molding the disk structure to include a data storage area and metalizing a layer over the data storage area after the processor is positioned on the disk to create the metalized data storage area. Alternatively, the positioning step may include positioning the processor in the data storage area and the metalizing step includes metalizing in an area over the processor. The metalized layer may be shaped into a pattern in the area positioned over the processor. A non-conductive layer may be positioned over the processor prior to metalization.

The providing step may include molding a disk structure having a recess sized for receiving the processor and the positioning step includes positioning the processor in the recess. The process may also include depositing a coating in the recess over the processor. Alternatively, the positioning step may include pressing the processor into the disk structure. In another embodiment, the positioning step includes applying an adhesive to the disk structure in a predefined area, applying the processor to the disk structure in the predefined area, and curing the adhesive to affix the processor to the disk structure.

The disk structure may have a disk surface with the metalized data storage area positioned on the disk surface. The data storage area may comprise a plurality of pits corresponding to data and a data free area, both of which are covered by the metalized layer. The positioning step may comprise positioning the processor in the data free area of the data storage area. A non-conductive layer may be positioned over the processor. A pattern may be formed in the metalized layer in the data free area of the metalized data storage area by laser ablation, etching, or mechanical removal.

In another embodiment, the disk structure includes two disk layers that are bonded together and the positioning step comprises positioning the processor between the two disk layers. An exterior surface of the two disk layers may be covered with a protective coating. The positioning step may include coupling the processor to an exterior surface of one of the disk layers and covering the processor with a protective coating. The providing step may include forming a recess in one of the disk layers for receiving the processor and positioning the processor in the recess. A recess may be formed in both disk layers, and the processor may be positioned between the two disk layers within the recesses.

In an alternative embodiment, the process also includes coupling an antenna to the disk structure and coupling the processor to the antenna. The disk structure has a center and an outer periphery and the metalized data storage area is positioned in the vicinity of the outer periphery of the disk structure and spaced from the center. The antenna may be coupled to the disk structure between the center and the metalized data storage area. The positioning step may include positioning the processor between the metalized data storage area and the antenna on the disk structure. Alternatively, the antenna and processor may be coupled to the disk structure between the metalized data storage area and the outer periphery.

### BRIEF DESCRIPTION OF THE DRAWING FIGURES

FIG. 1 is an elevated top view of a disk according to the claimed invention, showing a processor installed in an inner region of the disk structure;

FIG. 2 is a partial cross-sectional view of a CD configuration of the disk of FIG. 1, taken along line 2-2, showing the processor positioned on the disk surface;

FIG. 3 is a partial cross-sectional view similar to FIG. 2, but showing the processor positioned in a recess on the disk surface;

FIG. 4 is a partial cross-sectional view similar to FIG. 2, but showing the processor after it has been pressed into the disk surface;

FIG. 5 is a partial cross-sectional view of a DVD configuration of the disk of FIG. 1, taken along line 2-2, showing the processor positioned between the two disk layers of the disk;

FIG. 6 is a partial cross-sectional view similar to FIG. 5, but showing the processor embedded in the bonding material between the two disk layers of the disk;

FIG. 7 is a partial cross-sectional view similar to FIG. 5, but showing the processor positioned in a recess formed in one of the disk layers;

FIG. 8 is a partial cross-sectional view similar to FIG. 5, but showing the processor positioned in a recess defined in both of the disk layers;

FIG. 9 is a partial cross-sectional view similar to FIG. 5, but showing the processor embedded in a recess defined on an exterior surface of the disk layers;

FIG. 10 is a partial cross-sectional view similar to FIG. 9, but showing the processor positioned on an exterior surface of one of the disk layers with the disk layers being covered with a protective coating;

FIG. 11 is an elevated top view of an alternative embodiment of the disk showing the processor embedded in an outer peripheral ring of the disk structure;

FIG. 12 is a partial cross-sectional view of the disk of FIG. 11, taken along line 12-12, showing the processor positioned on the disk surface;

FIG. 13 is a partial cross-sectional view similar to FIG. 12, showing the processor embedded in a recess defined on the disk surface;

FIG. 14 is a partial cross-sectional view similar to FIG. 12, showing the processor after it has been pressed into the disk surface;

FIG. 15 is a top elevated view of an alternative embodiment of the disk showing the processor positioned in the metalized data storage area of the disk structure;

FIG. 16 is a partial cross-sectional view of the processor of FIG. 15, taken at lines 16-16, showing the processor positioned on the disk surface under the metal layer of the metalized data storage area;

FIG. 17 is a partial cross-sectional view similar to FIG. 16, but showing the processor after it has been pressed into the surface of the disk;

FIG. 18 is a partial cross-sectional view similar to FIG. 16, but showing the processor positioned in a recess defined on the surface of the disk;

FIG. 19 is a partial cross-sectional view similar to FIG. 16, but showing the processor positioned in a recess defined on the surface of the disk with a pattern or shape cut into the metal layer of the metalized data storage area in the vicinity of the processor;

FIG. 20 is a partial cross-sectional view of an alternative embodiment of the disk, similar to that of FIG. 16, showing a pattern or shape cut into the metal layer of the metalized data storage area in the vicinity of the processor;

FIG. 21 is a partial cross-sectional view similar to FIG. 16, but showing the processor covered by a non-conductive layer under the metal layer;

FIG. 22 is a partial cross-sectional view similar to FIG. 16, but showing the processor covered by a non-conductive layer under the shaped metal layer;

FIG. 23 is a top elevated view of the disk showing several alternative embodiments when a processor utilizing a separate antenna is utilized;

FIG. 24 is a partial top view of the inner area of the disk showing a different type of antenna configuration;

FIG. 25 is a partial top view similar to FIG. 23, but showing a different type of antenna shape; and

FIG. 26 is a partial top view similar to FIG. 23, but showing a different type of antenna shape.

### DETAILED DESCRIPTION

The claimed invention concerns an information disk 10 having a substantially rigid structure with a surface 12 on which a radio frequency identification (RFID) processor 14 is positioned. The processor 14 may be associated with any type of information disk, such as a single disk, as in the case of a compact disk (“CD”), or multiple laminated disks, as in the case of a Digital Versatile Disk (“DVD”). Data is stored on the disk 10 in a metalized data storage area 16. The processor 14 is activated or enabled by light of the ultraviolet radiation, visible spectrum, and infrared radiation segments of the electromagnetic spectrum. Light in these areas is generically termed herein as “short wavelength electromagnetic light,” as compared to microwave or radio waves. One type of light that is utilized to activate the processor 14 is laser light. Light from a laser in a player provides the processor 14 with power to transmit data stored in the processor 14 to an outside source via radio or microwaves.

CD and DVD players currently utilize laser light to read data stored in the metalized data storage area 16 of the disk 10. Because the processors 14 utilized with the claimed invention are sensitive to light, when the disk 10 is positioned in a CD or DVD player, the laser light, in the normal course of player operation, can activate or enable the RFID processor 14 positioned on the disk 10. This is dependent on whether the laser and processor are relatively positioned to interact with one another. Alternatively, a separate light source may be utilized to activate or enable the RFID processor 14 stored on the disk 10. It may be desirable to have a separate light source in order to allow for greater flexibility in processor placement, or when light of a different frequency or wavelength is required to activate the processor or otherwise desired.

Once the processor 14 is enabled, it can send a radio or microwave signal to an outside source, including in the signal information that is stored in the processor 14. This information can be used to determine the authenticity of the disk 10 positioned in the player. It can be used to prevent copying or playing of the disk 10 if it is found that the disk 10 is not an authorized or authentic copy. It can also be used to prevent unauthorized copying of copyrighted or otherwise secured information on the information disk 10. Thus, the present invention can utilize an existing feature of a player—the laser light—to activate the RFID processor 14. Other types of light may also be utilized to activate the processor 14, including light in the ultraviolet, visible, and infrared regions of the spectrum, the invention not being limited to activation by laser light.

The present design uses standard CD and DVD construction and positions a light activated processor 14 on the disk 10. A CD has an annular disk structure approximately 12 centimeters in diameter and 1.2 millimeters thick, with an approximately 1.6 centimeter diameter central opening 18. CDs are typically made from a polycarbonate base 20 in an injection molding process. During molding, data in the form of tiny pits in a spiral pattern 22 are pressed into the disk surface 12 of the base 20, and the data portion on the surface of the CD is then coated with a thin layer of metal to form the metalized data storage area 16. A typical metallic coating material is aluminum, copper, or gold. The data storage area 16 is typically a ring-shaped area that is concentric to the annular disk structure, with an inner diameter of approximately 4.125 centimeters and an outer diameter of approximately 11.75 centimeters. The data storage area 16 preferably does not extend to the outer periphery 24 of the disk 10, leaving a thin non-metalized annular ring 26 at the outer periphery 24 and another annular non-conductive portion 28 at the center of the disk 10.

The entire disk surface 12 of the base 20 is typically covered by a transparent protective coating 30, such as acrylic or nitrocellulose, to protect the metalized data storage area 16. The interior non-conductive portion 28 of the CD (between the data storage area 16 and the central opening 18), previously did not contain any information aside from occasional printed information. A light enabled processor 14 is now positioned on the disk 10 in the interior non-conductive portion 28. In a preferred embodiment, the processor 14 includes an onboard antenna. Processors that do not have onboard antennas may also be utilized, as will be discussed in greater detail below. Once the processor 14 is activated by a light source, the processor 14 transmits data stored in the processor 14 to a reader positioned near the CD inside a player. The processor 14 may be positioned in a variety of positions on the disk surface 12, which will each be discussed in connection with the respective figures.

DVDs have approximately the same physical dimensions as the CDs discussed above, but include multiple data storage areas, such as two disk layers 32 that are 0.6 millimeters thick. The metalized data storage areas 16 on each layer 32 of a DVD are parallel to each other and serve as reflective layers.

Like CDs, DVDs are formed using an injection molding process. In one such process, two molds are utilized to make a single DVD. Each mold produces a 0.6 mm disk layer 32. A plastic, such as polycarbonate, is heated to a molten state and fed into the mold. The plastic layer 32 is compressed in the mold under several tons of pressure so that the pits 22 corresponding to the data are pressed into the disk layer 32. The clear plastic layers 32 are then chilled and removed from the mold. After each layer 32 is pressed, the disk layers are coated with a metallic layer to cover the pits 22 and form the metalized data storage area 16. A preferred coating technique is sputter coating and preferred materials are aluminum, copper, or gold. The two disk layers 32 are then bonded together with a bonding material 36, such as lacquer, and UV light is applied as the disk layers 32 are squeezed together. The exterior surfaces 38 of the disk layers 32 may also be coated with a protective layer 30. A processor 14 is positioned on the disk 10 between the two disk layers 32 or on an exterior surface 38 of the disk layers.

The term “processor” as used herein refers generally to a computer that processes or stores information, such as a computer chip that is enabled or activated by light, including ultraviolet, visible, and infrared. The processor has a semiconductor circuit with logic, memory and RF circuitry, as well as photocells or other light sensitive components for activating the circuit once exposed to light. The processor 14 may include a computer chip in conjunction with an interposer, a computer chip in conjunction with leads for attaching the computer chip to an antenna, a computer chip with terminals for electrical connection with an antenna, or a chip with an onboard antenna, among other configurations. The computer chip may be a silicon-based chip, a polymer based chip, or other chips that are known today or will be developed in the future. Thus, the term “processor” as used herein is meant to encompass a variety of embodiments and configurations.

In a preferred embodiment, the processor 14 is a chip manufactured by Pharmaseq of Princeton, N.J. The Pharmaseq chip is small in size, having dimensions of approximately 0.5 mm×0.5 mm×75 microns, and is low in cost. The small size is preferred because it is less noticeable to the user when positioned on a disk. It is activated by laser light, is read only, and has an onboard antenna that permits short read distances that are suitable for the close quarters within a CD or DVD player. Other types of processors are also contemplated for use with the present invention, as long as they are light activated.

The processor 14 utilized with the current design is enabled by short wavelength electromagnetic light in the ultraviolet, visible and infrared spectrums. The processor 14 is preferably enabled by light having a frequency ranging from about 3×10¹⁷ Hz up to about 300 GHz, and a wavelength ranging from about 1 nanometer up to about 25 micrometers. A more preferred wavelength for activating the processor, generally corresponding to laser light, is about 380 nanometers to about 750 nanometers.

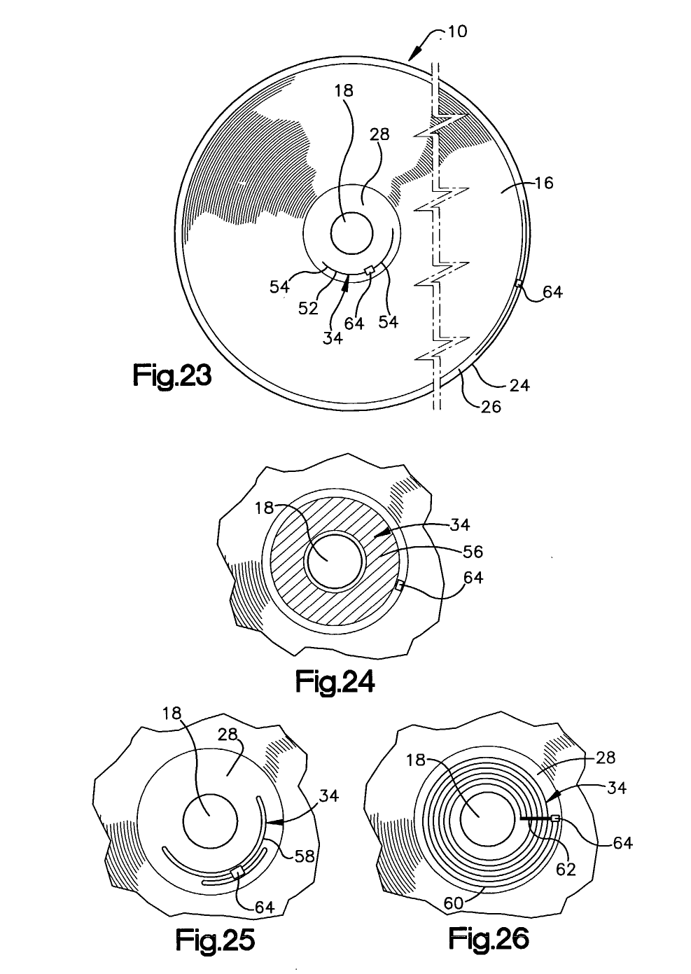

Referring to the figures, FIGS. 1-22 depict a disk 10 having a processor 14 with an onboard antenna and FIGS. 23-25 depict a disk 10 having a processor 14 that utilizes an antenna 34 that is positioned on the disk structure. FIGS. 1-22 depict several different positions for the processor 14 on the disk 10, as well as numerous different constructions of the various layers of the disk 10. The processor 14 may be embedded in the disk structure so that it is more covert. Alternatively, the processor may be positioned on the outer surface of the disk structure, in a potentially less covert manner.

FIG. 1 shows a disk 10 where the processor 14 is positioned in a non-conductive inner portion 28 of the disk base 20. The processor 14 is positioned adjacent the metalized data storage area 16, which is advantageous in that the path of the laser in the player may be utilized to activate the processor 14 as part of the normal path of operation that the laser uses to read data stored in the metalized data storage area 16. The processor 14 may also be positioned at other positions within the inner non-conductive portion 28, such as closer to the central opening 18, if so desired.

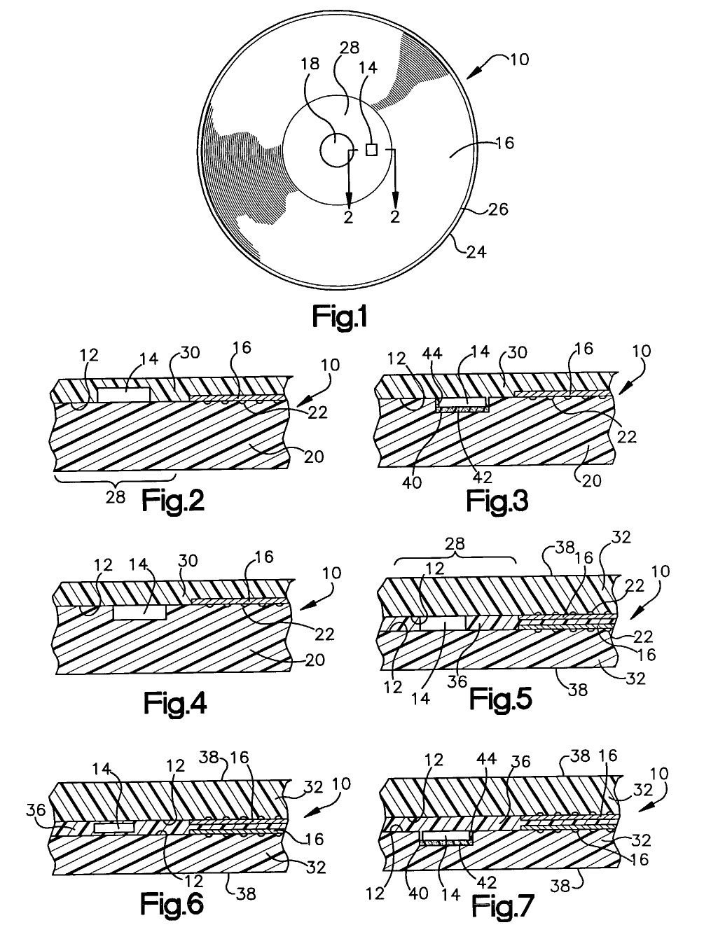

FIGS. 2-4 show various configurations for a CD construction, where the processor 14 is associated with the disk surface 12 of the base 20. In FIG. 2, the processor 14 is positioned on the disk surface 12, and the surface 12, processor 14, and metalized data storage area 16 are coated with a protective coating 30. The processor 14 may be positioned on the surface 12 utilizing an adhering medium, such as an adhesive or epoxy. In one embodiment, the processor 14 is connected to the surface using a UV curable adhesive. The adhesive is applied to either the disk surface or the processor 14, the processor is positioned on the disk surface 12, and the adhesive is cured to affix the processor 14 to the surface 12.

FIG. 3 shows a processor 14 positioned in a recess 40 that is formed in the disk surface 12. The recess 40 may be formed during the molding process of the disk base 20, or after the disk base 20 has been molded. Where the recess 40 is formed after the disk base 20 is molded, it may be formed by any known technique, such as laser ablation, or chemical or mechanical removal, among other techniques known by those of skill in the art. The recess 40 is preferably sized to accept the entire size of the processor 14. Small gaps 44 may be positioned around the processor 14 in the recess 40. These gaps 44 may be filled in with the protective coating 30, or with another filler. The processor 14 may be connected to the surface 12 in the recess 40 utilizing an adhesive 42 or other adhering material, although an adhesive is not always required.

FIG. 4 shows the processor 14 after it has been pressed into the surface 12 of the disk base 20 during the molding process. Pressing the processor 14 into the disk surface 12 is advantageous because the size of gaps 44 around the processor 14 is minimized. Any gaps 44 that are present after the processor 14 is pressed into the disk surface 12 may be filled in by the protective coating 30, or by another filler is so desired.

FIGS. 5-10 depict a DVD construction corresponding to FIG. 1, where the processor 14 is positioned in the inner non-conductive area 28 of the disk base 20. As discussed above, DVDs include two disk layers 32 that are bonded together using a lacquer, or other suitable bonding material 36. In a preferred embodiment, the processor 14 is sandwiched between the disk layers 32, as shown in FIGS. 5-8. This is advantageous in that the processor may be made more covert than if the processor 14 were placed on an exterior surface of the DVD. Alternatively, the processor may be positioned on an exterior surface 38 of the disk layers 32, as shown in FIG. 9-10. In each of FIGS. 5-9, a bonding material 36 is positioned between the metalized data storage areas 16 and the disk layers 32.

FIGS. 5-10 show the processor 14 positioned on the DVD in a variety of configurations. In FIG. 5, the processor 14 is positioned between the disk layers 32 with the bonding material 36 positioned around the sides of the processor 14 and between the metalized data storage areas 16. The processor 14 may be bonded to the disk layers 32 utilizing a different, or the same bonding material 36 as utilized to bond the upper and lower layers 32 together. For instance, a separate adhesive 42 may be applied directly to the processor or surface so that the processor can be adhered to one of the disk surfaces 12. Alternatively, the processor 14 may simply be held in position between the disk layers 32 by the surrounding bonding material 36.

FIG. 6 is similar to FIG. 5, but shows the processor 14 embedded within the bonding material 36 utilized to bond the upper and lower layers 32 together. The bonding material 36 fills the space between the layers 32 and completely surrounds the processor 14 so that the processor 14 is suspended in the bonding material 36. Alternatively, one surface of the processor 14 may be attached to the disk surface and the remaining surfaces of the processor may be surrounded by the bonding material.

FIG. 7 shows the processor 14 embedded below the surface 12 of the lower disk layer 32 in a recess 40 formed in the surface 12. The recess 40 may be formed in the surface 12 during the disk layer molding process. Alternatively, the recess 40 may be formed after the disk layer 32 is formed, as discussed above for the CD configurations. An adhesive 42 may be coupled to the processor 14 or to the recess 40 so that the processor 14 adheres to the recess 40 once it is placed in the recess 40. The recess 40 is preferably sized to accept the entire size of the processor 14. Gaps 44 may be formed between the processor 14 and the recess 40 due to differences in size between the processor 14 and the recess 40. These gaps 44 can be filled in with a filler, or may be filled in by the bonding material 36 that is utilized to join the disk layers 32 together. The disk layers 32 are bonded together utilizing the bonding material 36, which is shown positioned between the disk layers 32. In this embodiment, the gap between the layers 32 may be smaller than in prior embodiments, since the processor 14 is embedded within the disk layer 32.

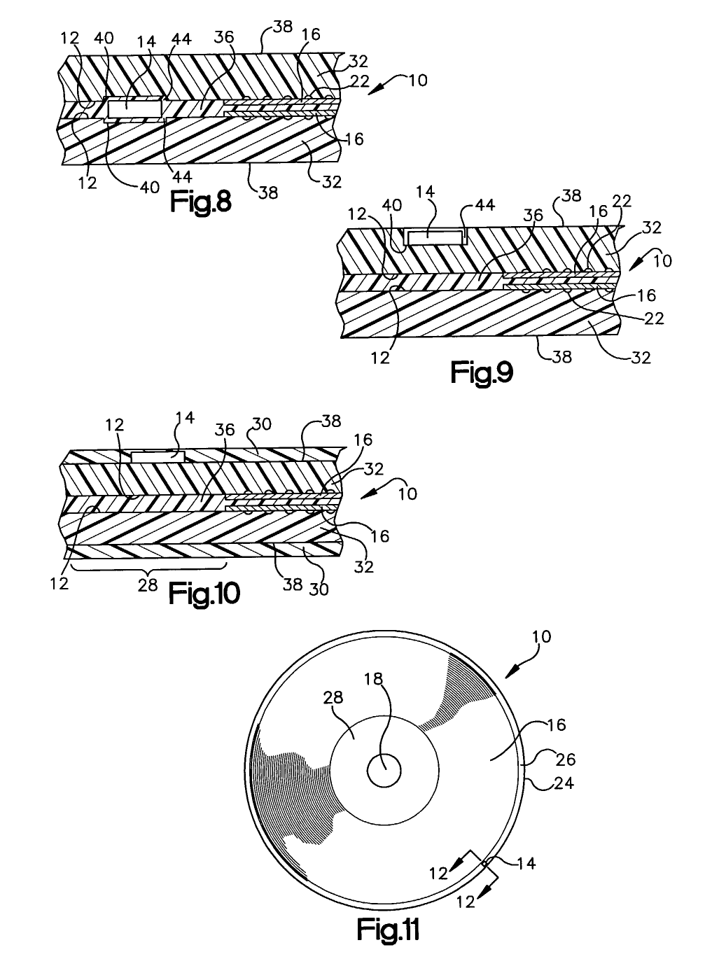

FIG. 8 shows the processor 14 positioned within recesses 40 that are formed in both the upper and lower layers 32. As with the prior embodiment, the recesses 40 may be formed during the molding process of the disk layers 32, or after the disk 10 is molded. The recesses 40 are preferably precisely positioned on the disk layers 32 so that the processor seats within both recesses 40 when the disk layers are bonded together. Gaps 44 may be present in the recesses 40 around the processor 14, and may be filled in by the bonding material 36 that is utilized to connect the two disk layers 32 together, or another filler material. An adhesive 42 may be positioned on the processor 14 or in the recesses 40 in order to adhere the processor 14 to the recesses 40. This adhesive 42 may assist in filling the gaps 44 around the processor 14 in the recesses 40.

FIG. 9 shows the processor 14 positioned on an exterior surface 38 of the upper layer 32 in a recess 40 that is formed in the exterior surface 38 by any of the techniques discussed above. The processor 14 may alternatively be pressed into the surface 38 during the disk layer molding process so that the processor 14 becomes embedded in the exterior surface 38. Gaps 44 may be present around the processor 14 in the recess 40 or after it has been embedded in the exterior surface 38. A filler may be used to fill in any gaps. The filler is utilized to entirely fill in any remaining space within the recess 40 so that the exterior surface 38 of the disk is smooth. A smooth exterior surface 38 will make the position of the processor 14 more covert than if the processor were simply placed on an exterior surface 38 of the disk layer 32. The filler may be an adhesive or other material, such as bonding material 36. An adhesive 42 or other adhering medium may also be utilized to attach the processor 14 within the recess 40.

FIG. 10 shows the processor 14 positioned on an exterior surface 38 of the upper disk layer 32. The processor 14 may be adhered to the surface 38 with an adhering material, such as adhesive or epoxy. In this embodiment, the exterior surfaces 38 are covered with a protective coating 30, similar to the protective coating 30 utilized with the CD constructions. In order to maintain a DVD that has a standard thickness, with this embodiment it may be necessary to make the disk layers 32 slightly thinner than with prior embodiments in order to accommodate the thickness of the protective coating 30. The protective coating 30 over the processor 14 is advantageous in that it is not necessary to provide a recess 40 in the exterior surface, and the protective coating 30 will provide a smooth exterior surface 38 for more covert positioning of the processor 14.

While the processor 14 is shown in FIGS. 9 and 10 positioned on the upper disk layer, the processor 14 may alternatively be positioned on either the upper or lower disk layer 32 utilizing any of the above placements. While a protective layer 30 is shown on the exterior surface 38 in FIG. 10, a protective layer 30 is not required in all cases. Where a covert processor is not required, the processor 14 could be directly bonded to the exterior surface 38 without any protective coating 30 surrounding the processor 14. The protective layer may be selectively applied to the processor 14 in the vicinity of the processor only, if so desired, such as a small bubble of protective coating 30 surrounding the processor in order to protect the processor from damage. The gaps 44 around the processor 14 in recess 40 do not have to be filled in. If the processor 14 is positioned directly on the unrecessed surface 12 of the disk 10, the processor 14 is preferably strongly bonded to the surface 12 so that it cannot be easily removed. Again, the disk layers 32 in FIGS. 9-10 are bonded together utilizing techniques known by those of skill in the art, some of which are discussed above.

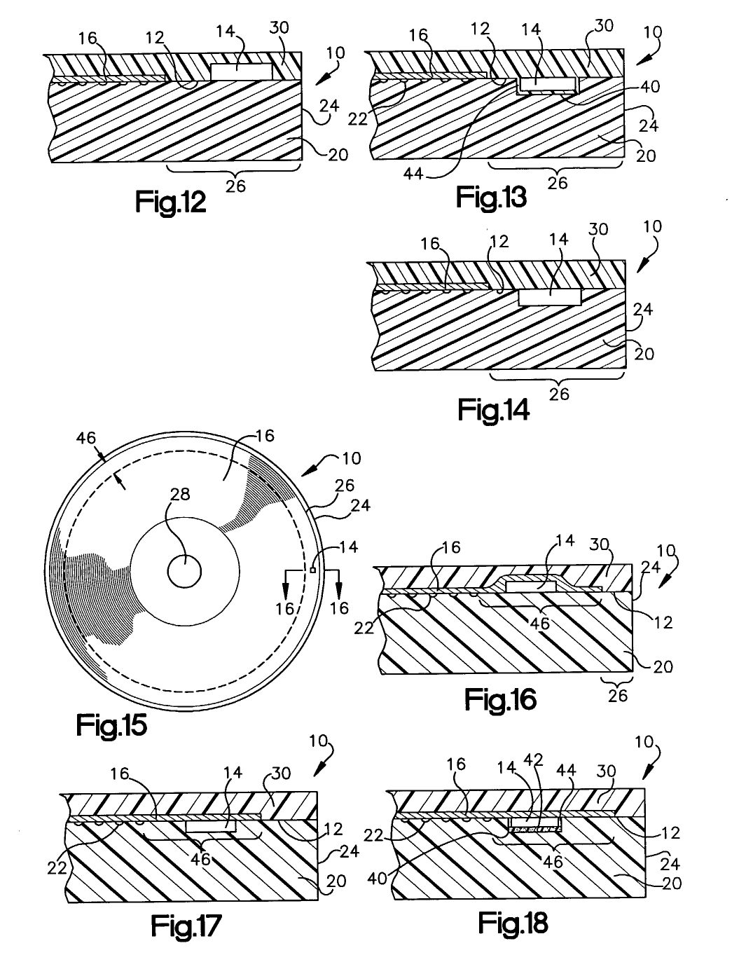

FIGS. 11-14 show an alternative embodiment of the disk 10, where the processor 14 is embedded in the outer non-conductive ring 26 of the disk base 20. The processor 14 is preferably small enough so that it can be embedded within the outer non-conductive ring 26 without interfering with the data storage area 16, or extending past the outer periphery 24 of the disk 10. FIGS. 12-14 show different ways in which the processor 14 may be embedded in a CD.

FIG. 12 shows the processor 14 positioned on the disk surface 12. The disk surface 12, including the metalized data storage area 16 and processor 14 are covered by a thin protective layer 30. The processor 14 may be adhered to the surface 12 with an adhering medium, such as epoxy or adhesive. Alternatively, the protective coating 30 may be utilized to hold the processor 14 in place on the surface 12. The protective coating 30 preferably provides a smooth surface on the CD so that the processor is somewhat covert.

FIG. 13 shows the processor 14 embedded in a recess 40 on the disk surface 12 and then covered by the protective coating 30. In this embodiment, the protective coating 30 preferably flows into any gaps 44 between the processor 14 and the walls of the recess 40. FIG. 14 shows the processor 14 embedded in the disk surface 12. As with prior embodiments, the processor 14 may alternatively be pressed into the disk surface 12 during the molding process. By pressing the processor 14 into the disk surface, the processor 14 may be held in position on the surface 12 without the need for additional adhering mediums. In addition, any gaps 44 that may surround the processor 14 are minimized.

While not shown, the processor 14 may alternatively be positioned on the exterior of the protective coating 30, or embedded in a recess 40 defined in the protective coating 30. These techniques are also applicable to a DVD, where the processor 14 may be embedded in either the disk surface 12 or the exterior surface 38. Like FIGS. 5-10, the processor 14 may be embedded between the disk layers 32 in the outer non-conductive ring 26. The processor 14 may be embedded within a recess 40 defined in either or both of the disk layers 32, or it may be positioned between the layers 32 and embedded in the bonding material 36. In addition, the processor 14 may be positioned on an exterior surface 38 of the disk layers 32, using any of the techniques described above in connection with FIGS. 5-10, or any other techniques for applying a processor 14 to a surface, whether to the disk layer surface, or to the protective layer surface.

FIGS. 15-22 show an alternative embodiment of the disk 10 where the processor 14 is positioned in the metalized data storage area 16 on the disk surface 12. In this embodiment, the processor 14 is preferably placed in a portion of the metalized data storage area 16 that is free of data. This data free area 46 may be provided by moving the data storage area on the disk surface 12, by limiting the size of the data storage area 16, or by extending the size of the metalized area 16. Positioning the processor 14 under the metalized area 16 helps to camouflage the processor.

While the processor 14 is depicted in FIG. 15 as being positioned near the outer periphery 24 of the disk 10 in the metalized data storage area 16, it may also be positioned at other locations on the disk surface 12, such as near the inner non-conductive portion 28 in the metalized data storage area 16, or at an intermediate position within the metalized data storage area 16. It may be more advantageous to extend the metalized area 16 inwardly, because the inner area 28 is presently unused in CDs and DVDs. The processor 14 may be positioned under the metalized area 16 to help to augment the signal from the processor's onboard antenna. The metalized area 16 may assist in increasing the strength of the signal from the processor 14 by serving as an additional antenna for coupling with the processor's onboard antenna.

FIG. 16 shows the processor 14 positioned on the disk surface 12, with the metalized area 16 extending over the processor 14. As shown, the processor 14 does not interfere with the data pits 22 on the surface 12 of the processor 14. The processor 14 is preferably positioned on the disk surface prior to metalization of the metalized data storage area 16 so that metal can be applied over the processor during the metalization process. The processor may be applied to the surface 12 utilizing an adhering medium, such as an adhesive or an epoxy. The disk surface 12, including the metalized area 16, is covered by a protective coating 30 after metalization.

FIG. 17 is similar to FIG. 16, but shows the processor 14 embedded in the disk surface 12. The processor 14 may be embedded in the disk surface 12 during the disk molding process by pressing the processor 14 into the disk surface 12, as discussed above. The metalized area 16 is deposited on the surface 12 after the processor 14 has been pressed into the surface 12. The metalized area 16 extends over the data pits 22 and processor 14. The disk surface, including the metalized data storage area 16, is then covered by the protective coating 30.

FIG. 18 is similar to FIG. 17, but shows the processor 14 embedded in a recess 40 defined in the disk surface 12. As discussed above, the recess 40 may be formed in the disk surface 12 by any known techniques, such as laser ablation, or chemical or mechanical removal. Alternatively, the recess 40 may be formed during the disk molding process. The recess 40 is preferably sized to accept the entire size of the processor 14. The processor 14 may be positioned in the recess 40 with an adhesive 42, or other adhering medium. The adhesive 42 can be applied to the processor 14, or positioned in the recess 40 under the processor 14. The adhesive 42 may form a layer under the processor 14, or may surround the processor 14 once the processor 14 is positioned in the recess 40, and assist in filling any gaps 44 that surround the processor 14 in the recess 40. The metalized layer covers the processor 14 and the data pits 22. If any gaps 44 are present around the processor 14 in the recess 40, the metalized layer will flow into the gaps 44. The disk surface 12, including the metalized data storage area 16, is coated with the protective coating 30.

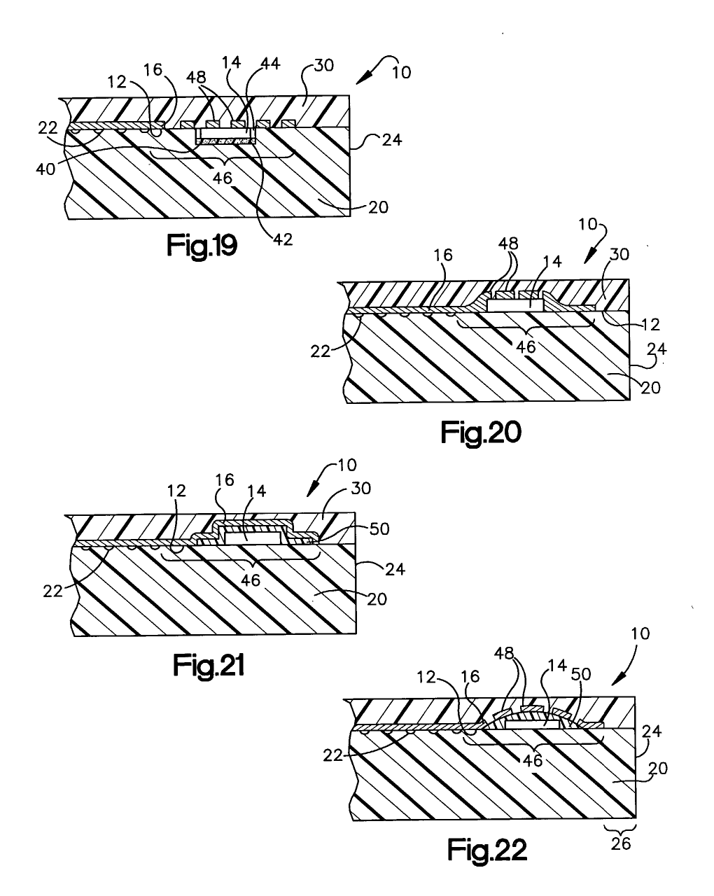

FIGS. 19 and 20 are views similar to prior views, but including a patterned area 48 of the metalized layer 16 positioned over the processor 14 while the processor 14 is positioned in a recess 40 (FIG. 19) or positioned on the disk surface 12 (FIG. 20). The patterned area 48 may assist in amplifying the signal from the processor 14 depending on the shape, size, and configuration of the pattern, and its coupling ability with the onboard antenna of the processor 14. The patterned area 48 may be formed in the metalized area 16 in the data free region 46 utilizing known techniques. For example, the patterned area 48 may be plated or sputter coated on the surface 12. A pattern 48 may be cut into the metalized surface 16 using such techniques as laser ablation, etching, or chemical or mechanical removal. Alternatively, the pattern 48 may be created by masking a portion of the disk surface 12 prior to metalization and removing the masking after metalization to reveal a shaped-pattern.

The patterned area 48 may take on numerous shapes, such as spiral, coil, or other loop configurations. Other shapes may be used, as known by those of skill in the art. The metalized layer on the data storage area 16 is typically a conductive material, such as aluminum or gold. These same materials may be coupled to the processor 14 in the data free area 46. Alternatively, other types of material may be applied in the data free area 46 of the metalized data storage area 16 so that the data free area 46 includes one type of conductive material while the remainder of the metalized data storage area 16 includes a different type of conductive material (not shown).

FIG. 21 is a view similar to FIG. 16, but including an additional non-conductive layer 50 positioned between the processor 14 and the metalized layer 16. The non-conductive layer 50 may be any type of non-conductive material, such as an adhesive or a polymer. The non-conductive layer 50 may be applied to the disk surface using known depositing techniques. The metalized layer 16 is positioned over the non-conductive layer 50 and the protective coating 30 is positioned over the metalized layer 16. The metalized layer 16 may capacitively couple to the processor 14 through the non-conductive layer 50.

FIG. 22 is a view combining the aspects of FIGS. 20 and 21. It includes a processor 14 positioned on the disk surface 12 that is coated by a non-conductive layer 50. The non-conductive layer 50 is covered by a metalized layer 16 that includes a patterned area 48 in order to assist in increasing the signal strength of the processor 14. The patterned area 48 was previously discussed in connection with FIGS. 19 and 20. The non-conductive layer 50 may be any type of non-conductive material, such as an adhesive or polymer. A non-conductive layer 50 could be applied to other embodiments discussed above, such as those including an embedded or recessed processor 14.

Each of the embodiments in FIGS. 15-22 are also applicable for DVD constructions. With DVD configurations, the processor 14 will be positioned under one of the metalized data storage areas 16 of one of the disk layers 32 in a data free area 46 on the disk surface 12.

FIGS. 23-26 show an alternative embodiment of the invention, where the light enabled processor 14 does not include an onboard antenna and, instead, is coupled to a separate antenna 34 that is positioned on the disk 10. All of the embodiments discussed above may be utilized with a processor 14 that does not include an onboard antenna, as long as provisions are made to couple an antenna 34 to the processor 14.

FIGS. 23-26 show several different antenna configurations. The processor 14 will typically have two terminals, with the terminals being connected to poles of the antenna 34. Each of the depicted antennas 34 could be used with the processor 14, whether the processor 14 is embedded in the disk surface 12 or an exterior surface 38, positioned in a recess 40 on the disk surface 12 or on an exterior surface 38, positioned on or in the protective coating 30, or otherwise attached to the disk surface 12 or disk layers 32. The antenna 34 can take on various forms depending on the type of RFID processor used, including both capacitive and inductive antenna systems. In addition, the antenna 34 may be any type of conductive material, such as copper or gold. As shown in FIGS. 23-26, several embodiments involve small parts of the inner area 28 to define a conductive area 34. Other embodiments do not require that any part of the inner area 28 be metalized, such as one of the embodiments shown in FIG. 23. The antenna 34 may be preformed and positioned on the disk 10, or it may be deposited directly on the disk 10 during the disk formation process.

FIG. 23 depicts a dipole antenna 52 coupled to a processor 14 at two different locations on the disk surface 12—in the inner non-conductive area 28 and the outer non-conductive ring 26. The processor 14 has two terminals and each of the terminals is connected to one of the arms 54 of the dipole antenna 52. The processor 14 and dipole antenna 52 may be coupled to the disk surface 12 by either being positioned directly on the surface 12, being embedded in the surface 12, or being positioned in a recess 40 defined on the surface 12. In each of these embodiments, the surface 12 is covered with a protective coating 30. Alternatively, the processor 14 and antenna 34 may be positioned within the protective coating 30 or on top of the protective coating 30. The size of the dipole antenna arms 54 may vary, depending upon the application requirements. The dipole antenna 52 and processor 14 may be positioned in a recess 40 defined on the disk surface 12. Alternatively, they may be positioned on a tag, which can be adhesively, or otherwise applied to the surface 12.

In the DVD configurations for FIG. 23, the processor and antenna may be positioned on one of the disk surfaces 12 of the disk layers 32 and then bonded to the other disk layer 32 with a bonding material 36, as discussed above in connection with FIGS. 5-10. Any of the positioning techniques discussed in FIGS. 5-10 may also be utilized to place the antenna 34 and the processor 14 on the disk 10. For instance, the processor and antenna may be positioned in a recess 40 on the disk surface of one of the disk layers 32 or on an exterior surface 38 of one of the disk layers, among other placement locations discussed in connection with FIGS. 5-10.

The antenna 34 may be deposited on the disk 10 using known depositing techniques, such as sputter coating or plating of metal, print depositing a conductive material, or hot foil stamping, among other techniques. In addition, the antenna may be preformed and positioned on a substrate, such as an adhesive layer, which may be applied directly to the disk 10. In addition, the processor 14 and antenna 34 may be positioned together on a preformed tag (not shown). The tag may be positioned on the disk in any number of ways, as discussed for processor 14 placement in any of the above embodiments.

FIG. 24 show the processor 14 coupled to both an inner metalized area of the disk 10 and the metalized data storage area 16 in a capacitive antenna system. While the inner area 28 of the disk 10 is not normally metalized, FIG. 24 shows that the inner area 28 may be metalized so that it may be utilized as an antenna 34. In another embodiment, the inner metalized area 56 may be shaped into an antenna pattern having two ends that may be connected to both terminals of the processor 14, and the processor 14 is only connected to the inner metalized area 56.

FIG. 25 shows a view similar to FIG. 23, but with a folded dipole antenna 58 positioned in the inner non-conductive area 28.

FIG. 26 shows a spiral loop antenna 60 associated with the processor 14. The spiral loop has two ends, one of which is coupled to one terminal of the processor 14 and the other of which is coupled to the other terminal of the processor 14. A bridging connector 62 is shown coupling the inner end of the loop antenna 60 with the processor 14. The bridging connector 62 may be electrically isolated from the inner antenna loops by an insulating dielectric, and the loops may be isolated from one another by the protective coating 26, or a different non-conductive material positioned over the bridging connector 62. The insulating dielectric may be the same material as the protective coating 26. While the processor 14 is shown positioned between the antenna 60 and the metalized data storage area 16, it may alternatively be positioned between the central opening 18 and the antenna 60.

The antenna 34 may be coupled to the processor 14 by any number of ways. It may be capacitively coupled, so that a direct physical connection between the terminals of the processor and the antenna is not required. It may be coupled by leads, traces, or other connections that extend from the antenna to the processor terminals. Alternatively, the processor terminals may be directly connected to the antenna. While not shown, an interposer may also be used in conjunction with the processor 14 for providing a connection between the antenna 34 and the processor 14.

The antenna may be positioned on the disk 10 in any number of ways. For instance, the antenna may be positioned on the disk surface 12 and covered by the protective coating 30. Alternatively, the antenna may be positioned directly on top of the protective coating 30. The antenna may also be embedded in either the disk surface 12 or protective coating 30, along with the processor 14. The antenna may be embedded while the processor 14 is not embedded, or vice versa.

In forming varied shapes for antenna 34, such as a coil, loop, or spiral, the inner area 28 of the disk is metalized and the antenna pattern may be cut into the metalized area using etching, laser ablation, or mechanical or chemical removal. A shaped antenna may also be formed using sputter coating, hot foil stamping, plating or other known techniques for forming shaped patterns of materials on surface 12. A shaped antenna 34 may also be formed by masking off parts of the disk surface 12, depositing material over the maskings and surface, and removing the maskings. With each technique, the RFID components are preferably covered with a protective coating after they are applied to the surface. The coating may be acrylic, nitrocellulose, or another suitable material, as known by those of skill in the art.

Different antenna configurations are discussed in greater detail in applicant's copending patent application filed on the same day and entitled “RFID Enabled Information Disks,” the disclosure of which is incorporated herein by reference in its entirety.

With either the CD or DVD configurations discussed above, the orientation of the processor 14 may be important to effective operation. Since the light enabled processor 14 includes photocells or other sensors for determining if a light signal has been transmitted, it may be necessary to orient the processor 14 so that photocells face the light source to allow the light source to activate or enable the processor 14 at the desired time. In one embodiment, such as that utilizing a chip that has photocells on one side, it is necessary to position the processor so that the photocells face the light source. Installing the processor 14 prior to metalization of the data storage area or printing a conductive material also allows an antenna to be built over the processor 14 instead of under the processor 14. It also eliminates the need for a conductive adhesive or solder to attach the processor 14 to the antenna in the embodiments where it is desired to couple the processor to an antenna. For the DVD application, the processor 14 could be positioned either on the upper or lower disk layer 32, as long as the photocells face the light source. Other processors may not require that the photocells face a predetermined direction. Some of these processors may include photocells on multiple surfaces, which would make it unnecessary to be concerned about proper photocell orientation.

The antenna may be a single layer of conductive material that is positioned on the disk surface 12 or in a recess 40. Alternatively, it may be a metallic layer, deposited by such techniques as hot foil stamping or sputter coating, or print depositing a layer of conductive material, such as a conductive ink, adhesive, or polymer. The antenna may be positioned above or below the protective coating 30. Conductive leads may be utilized, as discussed above, to establish an electrical connection between the processor, antenna, and metalized data storage area 16. These leads may be any type of conductive material known to those of skill in the art, such as conductive adhesive or solder.

While specific examples of CDs and DVDs are described above, the claimed invention is not limited to the specifically described embodiments. In particular, the dimensions provided above are for illustration purposes only. While the disks 10 are shown and discussed as being annular, non-annular disks may also be utilized. In addition to the types of CDs and DVDs described above, other types of CDs and DVDs are also contemplated to be used with the claimed invention, such as CD-ROM, CD-R, CD-RW, DVD-ROM, DVD-R(G), DVD-R(A), DVD-RW, DVD-RAM, DVD+RW, and DVD+R, among others. Further, different DVD formats may be utilized with the claimed invention, in addition to those with dual layers, including DVD-5 (single side, single layer), DVD-9 (single side, dual layer), DVD-10 (double side, single layer), DVD-14 (DVD-5 single layer bonded to a DVD-9 dual layer) and DVD-18 (two bonded DVD-9 dual layer structures).

While disks 10 having certain layer thicknesses are shown in the figures, the various relative thicknesses are for illustration purposes only. The actual disk structures may vary from the sizes and dimensions shown herein.

It should be further noted that a reader is utilized to read the processor 14 once installed on the disk surface 12. With some of the above-discussed embodiments, a reading of the processor 14 may require physical contact between the reader and the disk 10. In other embodiments, physical contact between the reader and the disk 10 is not required. Whether direct contact is necessary will depend on a number of factors, including antenna strength, shape, and size, and processor positioning and characteristics, among other things.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. An information disk comprising:
a disk structure having a metalized data storage area; and
a short wavelength electromagnetic light activated radio frequency identification processor coupled to said disk structure.

2. The information disk of claim 1, wherein said processor is embedded in the disk structure.

3. The information disk of claim 1, wherein the disk structure includes a surface and a protective coating that covers at least a part of the surface, with said processor being coupled between the surface and the protective coating.

4. The information disk of claim 3, wherein a recess is positioned on the surface of the disk, said recess being sized for receiving the processor therein.

5. The information disk of claim 1, wherein the disk structure has an outer periphery, and the processor is positioned at the outer periphery of the disk structure.

6. The information disk of claim 1, wherein the disk structure has an outer periphery and a center, with the metalized data storage area being positioned adjacent the outer periphery, and the processor being positioned between the center and the metalized data storage area.

7. The information disk of claim 1, wherein the disk structure has an outer periphery and a center, and the processor is coupled to the disk structure between the outer periphery and the center.

8. The information disk of claim 7, wherein the metalized data storage area has a data free portion, and the processor is coupled to the disk structure in the data free portion.

9. The information disk of claim 1, wherein the processor has a photo-active side and the photo-active side of the processor is oriented on the disk structure in a direction to allow activation of the processor by short wavelength electromagnetic light.

10. The information disk of claim 1, wherein the processor is coupled to the disk structure with an adhesive.

11. The information disk of claim 1, wherein the disk structure includes two disk layers that are bonded together and the processor is positioned between the two disk layers.

12. The information disk of claim 1, wherein the disk structure includes two disk layers that are bonded together, and the processor is coupled to an exterior surface of one of the disk layers.

13. The information disk of claim 1, wherein the processor is responsive to short wavelength electromagnetic light having a wavelength between about 1 nanometers and about 25 micrometers.

14. The information disk of claim 13, wherein the processor is responsive to short wavelength electromagnetic light having a wavelength between about 380 nanometers and 750 nanometers.

15. The information disk of claim 1, wherein the processor is responsive to laser light.

16. The information disk of claim 1, wherein the information disk is one of a CD-ROM, a CD-R, a CD-RW, a DVD-ROM, a DVD-R(G), a DVD-R(A), a DVD-RW, a DVD-RAM, a DVD+RW, and a DVD+R.

17. An information disk comprising:
a disk structure having a metalized data storage area; and
a radio frequency identification processor coupled to said disk structure, said processor being enabled by light having a frequency ranging from about 300 GHz to about 3×10¹⁷ Hz.

18. An information disk comprising:
a disk structure having a metallized data storage area; and
a radio frequency identification processor coupled to said disk structure, said processor being activatable by a light from an external source, said light being in at least one of the ultra-violet, visible, and infrared light areas of the electromagnetic spectrum.

19. The information disk of claim 18, wherein the light is laser light.

20. An information disk comprising:
a disk structure having a metalized data storage area;
a short wavelength electromagnetic light activated radio frequency identification processor coupled to said disk structure; and
an antenna electrically coupled to the processor.

21. The information disk of claim 20, wherein the antenna is internal to and integral with the processor.

22. The information disk of claim 20, wherein the antenna is coupled to the disk structure.

23. The information disk of claim 20, wherein the disk structure includes a disk surface and the processor and antenna are positioned on the disk surface.

24. The information disk of claim 23, wherein the processor and antenna are positioned on the disk surface, and further comprising a protective coating positioned over the disk surface, processor, and antenna.

25. The information disk of claim 23, wherein the disk structure includes a center and an outer periphery, the metalized data storage area is positioned on the disk surface near the outer periphery, and the antenna and processor are positioned on the disk surface between the metalized data storage area and the center.

26. The information disk of claim 25, wherein an opening is positioned in the center of the disk structure, the antenna is an annular ring of conductive material, and the processor is positioned between the annular ring of conductive material and the metalized data storage area.

27. The information disk of claim 25, wherein the antenna is one of a loop-shaped, a dipole, or a folded dipole.

28. The information disk of claim 23, wherein the disk structure includes an outer periphery, the metalized data storage area is positioned on the disk surface near the outer periphery, and the antenna and processor are positioned between the metalized data storage area and the outer periphery.

29. The information disk of claim 23, wherein the disk structure includes an outer periphery, the metalized data storage area is positioned on the disk surface near the outer periphery, and the metalized data storage area is the antenna.

30. The information disk of claim 23, wherein the processor is positioned in the metalized data storage area.

31. A process of enabling an information disk with an RFID processor comprising:
providing a disk structure having a metalized data storage area; and
positioning a short wavelength electromagnetic light activated radio frequency identification processor on said disk structure.

32. The process of claim 31, further comprising coating said disk structure with a coating to cover the processor and the metalized data storage area.

33. The process of claim 31, wherein the providing step includes molding the disk structure to include a data storage area and metalizing a layer over the data storage area after the processor is positioned on the disk to create the metalized data storage area.

34. The process of claim 33, wherein the positioning step includes positioning the processor in the data storage area and the metalizing step includes metalizing in an area over the processor.

35. The process of claim 34, further comprising shaping the metalized layer in the area positioned over the processor into a pattern.

36. The process of claim 34, further comprising positioning a non-conductive layer over the processor prior to metalization.

37. The process of claim 31, wherein the providing step includes molding a disk structure having a recess sized for receiving the processor and the positioning step includes positioning the processor in the recess.

38. The process of claim 37, further comprising depositing a coating in the recess over the processor.

39. The process of claim 31, wherein the positioning step includes pressing the processor into the disk structure.

40. The process of claim 31, wherein the positioning step includes applying an adhesive to the disk structure in a predefined area, applying the processor to the disk structure in the predefined area, and curing the adhesive to affix the processor to the disk structure.

41. The process of claim 33, wherein the disk structure has a disk surface with the metalized data storage area positioned on the disk surface, the data storage area comprises a plurality of pits corresponding to data and a data free area, both of which are covered by the metalized layer, and the positioning step comprises positioning the processor in the data free area of the data storage area.

42. The process of claim 41, wherein the positioning step further comprises positioning a non-conductive layer over the processor.

43. The process of claim 42, further comprising forming a pattern in the metalized layer in the data free area of the metalized data storage area by laser ablation, etching, or mechanical removal.

44. The process of claim 31, wherein the disk structure includes two disk layers that are bonded together and the positioning step comprises positioning the processor between the two disk layers.

45. The process of claim 44, further comprising covering an exterior surface of the two disk layers with a protective coating.

46. The process of claim 31, wherein the disk structure includes two disk layers that are bonded together, and the positioning step comprises coupling the processor to an exterior surface of one of the disk layers.

47. The process of claim 46, further comprising covering the processor with a protective coating.

48. The process of claim 31, wherein the disk structure includes two disk layers that are bonded together, and the providing step includes forming a recess in one of the disk layers for receiving the processor, and the positioning step includes positioning the processor in the recess.

49. The process of claim 31, wherein the disk structure includes two disk layers that are bonded together, and the providing step includes forming a recess in both of the disk layers, and the positioning step includes positioning the processor between the two disk layers within the recesses.

50. The process of claim 31, further comprising coupling an antenna to the disk structure and coupling the processor to the antenna.

51. The process of claim 31, wherein the disk structure has a center and an outer periphery and the metalized data storage area is positioned in the vicinity of the outer periphery of the disk structure and spaced from the center, and further comprising coupling an antenna to the disk structure between the center and the metalized data storage area.

52. The process of claim 51, wherein the positioning step includes positioning the processor between the metalized data storage area and the antenna on the disk structure.

53. The process of claim 31, wherein the disk structure has an outer periphery and the metalized data storage area is positioned in the vicinity of the outer periphery, and further comprising coupling an antenna and the processor to the disk structure between the metalized data storage area and the outer periphery.

54. The process of claim 44, further comprising coupling an antenna to the disk structure and coupling the processor to the antenna.
